(19) United States
(12) Patent Application Publication
(10) Pub. No.: US 2026/0171273 A1
(43) Pub. Date: Jun. 18, 2026

(54) CORE COMPONENT ASSEMBLY INCLUDING TEST SAMPLES FOR AN IN-CORE ACCELERATED IRRADIATION TEST

(71) Applicant: Westinghouse Electric Company LLC, Cranberry Township, PA (US)

(72) Inventors: Caleb Clement, Cranberry Township, PA (US); J. Brian Hall, Cranberry Township, PA (US)

(73) Assignee: Westinghouse Electric Company LLC, Cranberry Township, PA (US)

(21) Appl. No.: 18/981,071

(22) Filed: Dec. 13, 2024

(51) Int. Cl. G21C 3/334; G21C 3/30; G21C 3/32; G21C 3/33; G21C 17/06

(52) U.S. Cl. CPC G21C 3/334; G21C 3/30; G21C 3/32; G21C 3/3305; G21C 3/3315; G21C 17/06

(57) ABSTRACT

A core component assembly for use with a fuel assembly of a nuclear reactor is disclosed. The core component assembly comprises a baseplate and a segmented rod to extend into the fuel assembly. The segmented rod comprises a plurality of sample segments. Each sample segment comprises a tubular housing, a cylindrical cavity defined in the tubular housing, a first plug to seal a first end of the tubular housing, and a second plug to seal a second end of the tubular housing opposite the first end. The cylindrical cavity is to house one or more than one test specimen.

### FIELD

The present disclosure is generally related to nuclear power and, more particularly, is directed toward a core component assembly including one or more than one test specimen for an in-core accelerated irradiation test.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a core component assembly for use with a fuel assembly of a nuclear reactor is disclosed. The core component assembly comprises a baseplate and a segmented rod to extend into the fuel assembly. The segmented rod comprises a plurality of sample segments. Each sample segment comprises a tubular housing, a cylindrical cavity defined in the tubular housing, a first plug to seal a first end of the tubular housing, and a second plug to seal a second end of the tubular housing opposite the first end. The cylindrical cavity is to house one or more than one test specimen.

In various aspects, a method of irradiating a plurality of test specimens within a nuclear reactor is disclosed. The nuclear reactor including a fuel assembly comprising a first instrumentation tube and a second instrumentation tube. The method comprising placing a first segmented rod at least partially within the first instrumentation tube of the fuel assembly of the nuclear reactor. The first segmented rod comprising a first test specimen and a second test specimen spaced apart from the first test specimen. The method comprising positioning the first segmented rod relative to the first instrumentation tube such that the first test specimen is positioned at a first axial elevation relative to the fuel assembly and such that the second test specimen is positioned at a second axial elevation relative to the fuel assembly. The first axial elevation is different than the second axial elevation. The method comprising placing a second segmented rod at least partially within the second instrumentation tube of the fuel assembly of the nuclear reactor, the second segmented rod comprising a third test specimen and a fourth test specimen spaced apart from the third test specimen. The method comprising positioning the second segmented rod relative to the second instrumentation tube such that the third test specimen is positioned at the first axial elevation and such that the fourth test specimen is positioned at the second axial elevation. The method comprising leaving the first segmented rod and the second segmented rod in residence within the fuel assembly for a period of time such that the first test specimen and the third test specimen receive a first radiation dose, and such that the second test specimen and the fourth test specimen receive a second radiation dose that is different than the first radiation dose.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 is a perspective view of a nuclear reactor;

FIG. 2 is a perspective view of a core component assembly;

FIG. 3 is a perspective view of the core component assembly of FIG. 2 installed into a fuel assembly;

FIG. 4 is a cross section plan view of four fuel assemblies of the nuclear reactor of FIG. 1, illustrating a core component assembly positioned within two of the fuel assemblies;

FIG. 5 is a side elevation view of an irradiation test core component assembly, in accordance with at least one aspect of the present disclosure;

FIG. 6 is a cross section plan view of a fuel assembly illustrating the position of the irradiation test core component assembly within a fuel assembly of a nuclear reactor, in accordance with at least one aspect of the present disclosure;

FIG. 7 is a side elevation view of a segmented rod of the core component assembly of FIG. 5, in accordance with at least one aspect of the present disclosure;

FIG. 8 is a cross section view of a sample segment of the segmented rod of FIG. 7, in accordance with at least one aspect of the present disclosure;

FIG. 9 is a cross section view of a top end connector of the segmented rod of FIG. 7, in accordance with at least one aspect of the present disclosure;

FIG. 10 is a cross-section view of a spacer of the segmented rod of FIG. 7, in accordance with at least one aspect of the present disclosure;

FIG. 11 is a side elevation view of a first segmented rod and a second segmented rod of the core component assembly of FIG. 5, in accordance with at least one aspect of the present disclosure;

FIG. 12 is a perspective view of a rod for use with the core component assembly of FIG. 5, in accordance with at least one aspect of the present disclosure;

FIG. 13 is a perspective view of a sample segment for use with the rod of FIG. 12, in accordance with at least one aspect of the present disclosure;

FIG. 14 is a plan view of a tensile pull bar test specimen, in accordance with at least one aspect of the present disclosure;

FIG. 15 is a plan view of a threaded tensile bar test specimen, in accordance with at least one aspect of the present disclosure;

FIG. 16 is a perspective view of a bend bar test specimen, in accordance with at least one aspect of the present disclosure;

FIG. 17A is a plan view of a square compact tension test specimen, in accordance with at least one aspect of the present disclosure;

FIG. 17B is a plan view of a round compact tension test specimen, in accordance with at least one aspect of the present disclosure;

FIG. 18 is a perspective view of a plurality of disc test specimens, in accordance with at least one aspect of the present disclosure; and

FIG. 19 is a flow chart describing a method of irradiating a plurality of test specimens within a nuclear reactor, in accordance with at least one aspect of the present disclosure.

Corresponding reference characters indicate corresponding parts throughout the several views. The exemplifications set out herein illustrate various aspects of the disclosure, in one form, and such exemplifications are not to be construed as limiting the scope of the disclosure in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

In the following description, reference characters designate like or corresponding parts throughout the several views of the drawings. Also in the following description, it is to be understood that such terms as “forward”, “rearward”, “left”, “right”, “upwardly”, “downwardly”, and the like are words of convenience and are not to be construed as limiting terms.

Before explaining various aspects of the core component assembly in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

In general, there exists a critical need for reliable materials data for long-term irradiation performance of structural components in pressurized water reactor (PWR) environments. Historically, commercial nuclear reactor plants have validated their continued operation via surveillance capsule programs. Surveillance capsule programs consist of representative test specimens from reactor structural components (e.g., pressure vessel material) which are encapsulated and placed in slightly accelerated dose positions. The slightly accelerated dose positions for the surveillance capsules are located outside of the reactor core itself (e.g., in the downcomer flow region). The surveillance capsule programs provide the necessary data to ensure that the safety margins for radiation-induced embrittlement are sufficiently large enough to justify the continued operation of the nuclear reactor(s) beyond their initially planned operating lifetime (e.g., beyond 40, 60, or even more years). As operating plants continue to extend their operating life to 80 years and in some cases closer to 100 years, the amount of surveillance capsules remaining in the cores dwindles. In several instances, plants which would otherwise desire to continue operation have no remaining surveillance capsules with which to test and provide confidence in sufficient safety margins. Presently, Westinghouse Electric Company is pursuing the PWR Supplemental Surveillance Program (PSSP) in conjunction with industry partners at the Electric Power Research Institute (EPRI) and the PWR Owner's Group (PWROG). In addition, there is a desire to characterize and quantify irradiation performance for structural components such as the core barrel and thermal shields for degradation management. As such, there is a critical need for an alternative to the surveillance capsules programs that can provide the irradiation test data necessary to ensure safety margins to extend the operating life of older nuclear reactors.

One solution to the above mentioned issues is one or more than one irradiation test assembly (e.g., a core component assembly) which can be inserted into a fuel assembly of an operating nuclear reactor (e.g., during re-fueling). The core component assembly may include ASTM standard and NRC approved test specimens, which will receive accelerated irradiation during operation of the nuclear reactor. The test specimens can then be retrieved during a subsequent refueling operation for analysis. The analysis of the test specimens can then be used to justify the continued use of specific reactor plant structural materials beyond their current planned or approved operating lifetimes.

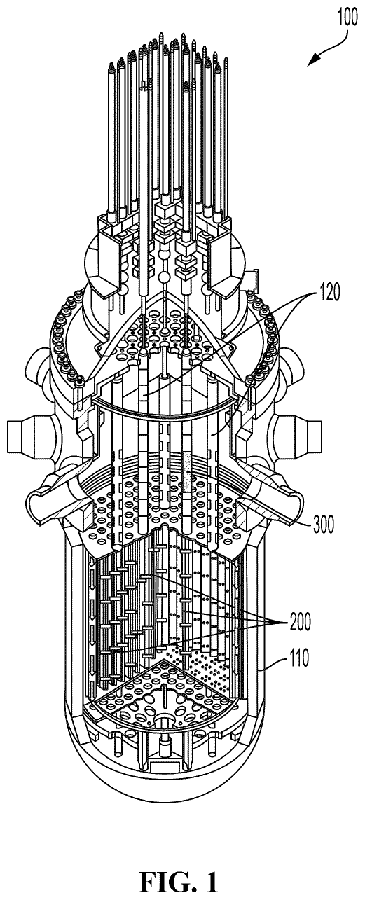

FIG. 1 illustrates a nuclear reactor 100 comprising a reactor vessel 110 including a plurality of fuel assemblies 200 positioned therein. A limited number of the fuel assemblies 200 are shown in FIG. 1 for illustrative purposes. The nuclear reactor 100 further comprises a plurality of core component guide tubes 120 above each of the fuel assemblies 200, and a plurality of core component assemblies 300 movable within the core component guide tubes 120. FIG. 1 Illustrates only one of the core component assemblies 300, however it should be understood that any number of core component assemblies 300 are movable through the core component guide tubes 120 for installation into the fuel assemblies 200. Further, the core component assemblies 300 may be of various types and designs depending on the fuel assembly type and/or region of the nuclear reactor 100 in which the core component assemblies 300 are required to be placed based on the design of the nuclear reactor 100. For example, one of the core component assemblies 300 for one of the fuel assemblies 200 may comprise a control rod core component assembly (e.g., poison control rods) and another one of the core component assemblies 300 placed in a different fuel assembly of the fuel assemblies 200 may be a moderator core component assembly such as a WABA (e.g., wet annular burnable absorber) core component assembly. In some instances, one or more of the fuel assemblies 200 may not have one of the core component assemblies 300 positioned therein based on the design of the nuclear reactor 100. Further, one or more of the core component assemblies 300 may be a COBA (e.g., cobalt burnable absorber) core component assembly. In some instances, one or more of the core component assemblies 300 may be an irradiation test material core component assembly, as discussed in greater detail herein.

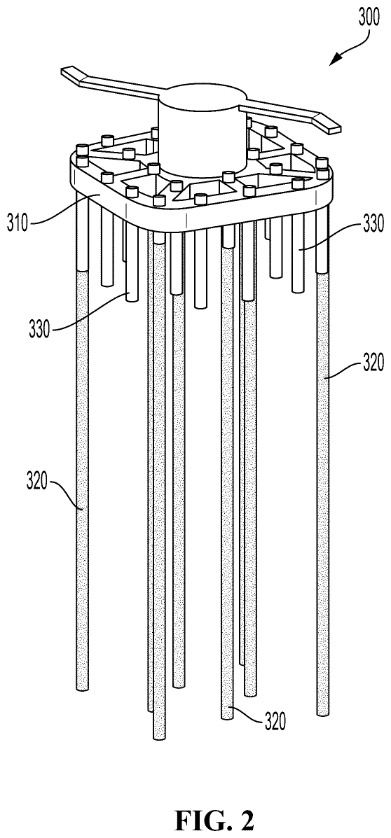

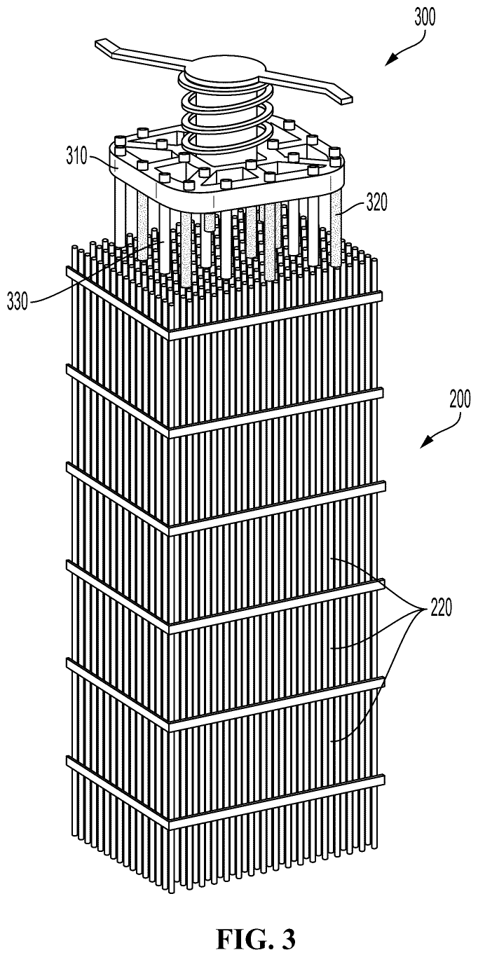

Further to the above, FIG. 2 illustrates a perspective view of one of the core component assemblies 300. In general, a typical core component assembly 300 comprises a baseplate 310 and a plurality of rodlets 320 attached to the baseplate 310. In at least one aspect, the core component assemblies 300 comprise a plurality of thimble guide tube plugs 330 that are also attached to the baseplate 310. FIG. 3 illustrates the core component assembly 300 of FIG. 2 installed into one of the fuel assemblies 200 of FIG. 1.

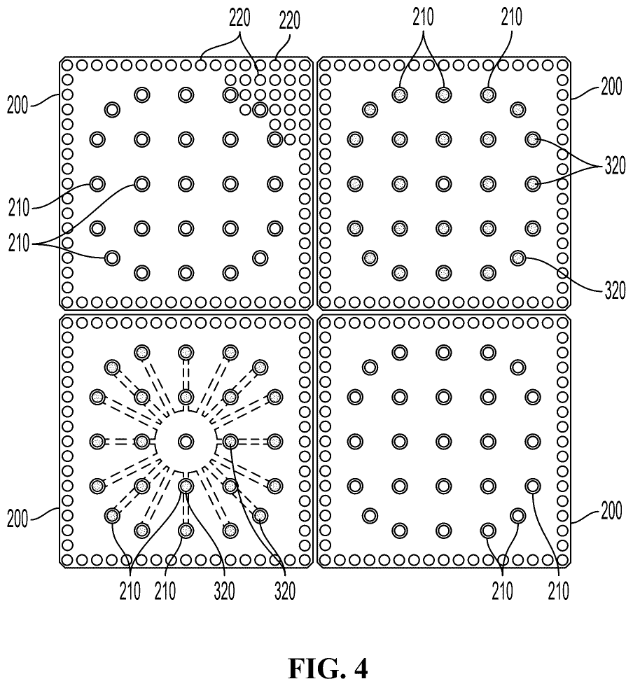

Further to the above, FIG. 4 illustrates a cross section view of a quadrant of the fuel assemblies 200 of the nuclear reactor 100 of FIG. 1. Each of the fuel assemblies 200 comprises a plurality of thimble guide tubes 210 and a plurality of fuel rods 220. When one of the core component assemblies 300 is inserted into one of the fuel assemblies 200 as shown in FIG. 3, the rodlets 320 and/or the thimble guide tube plugs 330 of the core component assembly 300 are positioned within respective thimble guide tubes 210 of the fuel assembly 200. Referring again to FIG. 4, the fuel assemblies 200 located in the upper left and bottom right do not have one of the core component assemblies 300 installed therein and the fuel assemblies 200 located in the upper right and bottom left have one of the core component assemblies 300 installed therein. Specifically, the rodlets 320 of the core component assemblies 300 are visible in the fuel assemblies 200 located in the upper right and bottom left of FIG. 4.

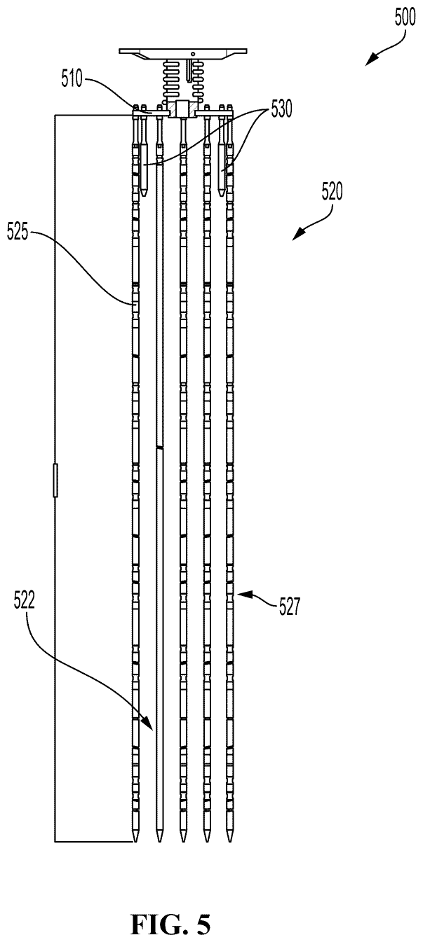

FIG. 5 illustrates a core component assembly 500 for insertion into a fuel assembly, such as the fuel assembly 200, of a nuclear reactor core. The core component assembly 500 is similar to the core component assembly 300 except for the differences discussed herein. The core component assembly 500 comprises a baseplate 510, a plurality of segmented rods 520 extending from the baseplate 510, one or more than one dummy rod 522 extending from the baseplate 510, and a plurality of thimble guide tube plugs 530 extending from the baseplate 510. In one embodiment, the plurality of thimble guide tube plugs 530 are similar to the thimble guide tube plugs 330 of core component assembly 300. Other embodiments are envisioned without the thimble guide tube plugs 530 and/or without the one or more than one dummy rod 522. In one embodiment, the one or more than one dummy rod 522 is a solid rod of zirconium material attached to the baseplate 510. In use, the baseplate 510 is positioned above the fuel assembly with the segmented rods 520, the one or more than one dummy rod 522, and the plurality of thimble guide tube plugs 530 extending into the fuel assembly instrumentation tubes.

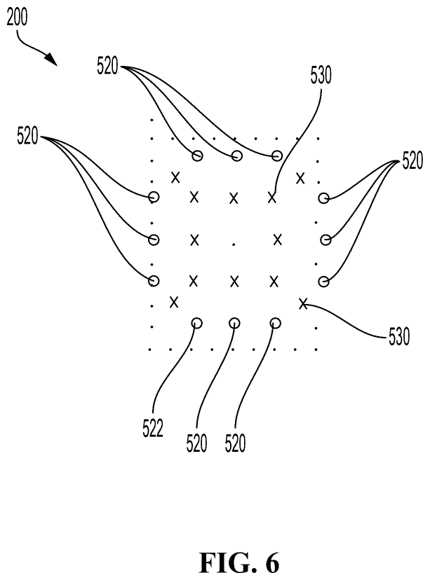

Further to the above, FIG. 6 illustrates a cross section plan view of the core component assembly 500 positioned within the fuel assembly 200. In the illustrated embodiment, the core component assembly 500 includes eleven segmented rods 520, one of the one or more than one dummy rods 522, and twelve thimble guide tube plugs 530. It should be understood that any number of segmented rods 520, and/or dummy rods 522, and/or thimble guide tube plugs 530 may be utilized with the core component assembly 500.

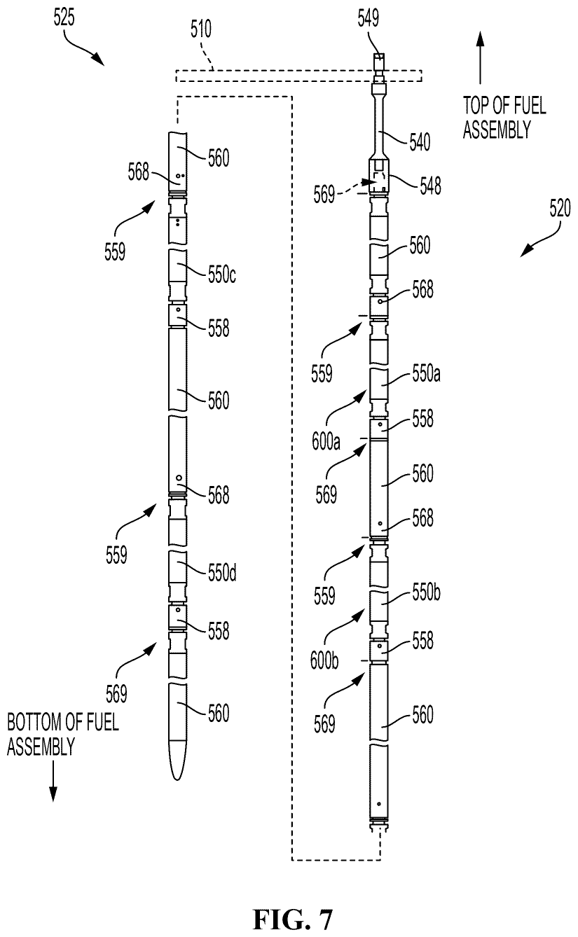

Referring to FIG. 7, a first segmented rod 525 of the plurality of segmented rods 520 is illustrated. In one embodiment, all of the segmented rods 520 may be identical to the segmented rod 525. In various embodiments, one or more than one of the segmented rods 520 may be different than the segmented rod 525. In any event, the segmented rod 525 comprises a top end connector 540, a plurality of sample segments 550a, 550b, 550c, 550d, and a plurality of spacers 560. The plurality of spacers 560 connect the sample segments 550a, 550b, 550c, 550d together and connect the sample segments 550a, 550b, 550c, 550d to the top end connector 540. The top end connector 540 is then attached to the baseplate 510 to attach the first segmented rod 520 to the baseplate 510. In one embodiment, one of the a plurality of sample segments 550a, 550b, 550c, 550d may be connected directly to another one of the a plurality of sample segments 550a, 550b, 550c, 550d. Further, the spacers 560 space apart the plurality of sample segments 550a, 550b, 550c, 550d and prevent, or substantially reduce, vibrational wear on the plurality of sample segments 550a, 550b, 550c, 550d during residence time in the reactor. In at least one embodiment, the top end connector 540, the plurality of sample segments 550a, 550b, 550c, 550d, and the plurality of spacers 560 define a total rod length greater than or equal to the axial length of a fuel assembly.

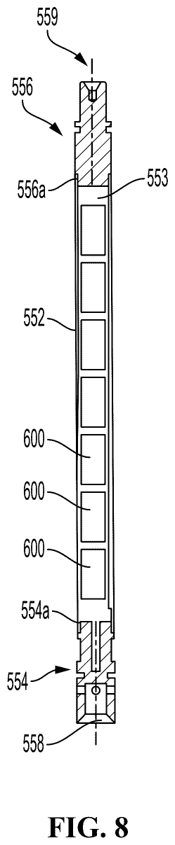

Referring to FIG. 8, each of the sample segments 550a, 550b, 550c, 550d comprises a tubular housing 552, a cylindrical cavity 553 defined in the tubular housing 552, a first plug 554 to seal a first end 554a of the tubular housing 552, and a second plug 556 to seal a second end 556a of the tubular housing 552 opposite the first end 554a. The cylindrical cavity 553 of each sample segment 550a, 550b, 550c, 550d is to house one or more than one test specimen 600. The first plug 554 includes a locking helicoil 558 and the second plug 556 includes a protrusion 559. In at least one embodiment, the protrusion 559 may be a threaded protrusion having external threads. In at least one embodiment, one or more than one of the sample segments 550a, 550b, 550c, 550d can be connected directly to each other by way of their respective locking helicoil 558 and protrusion, for example. Further, in various embodiments, the sample segments 550a, 550b, 550c, 550d can be connected to each other by way of the spacers 560.

In various aspects, the locking helicoils of the plurality of segmented rods 520, described herein, may comprise threaded inserts which go into a tapped hole, the threaded inserts creating a new threaded opening with a plurality of straight segments or chords. As a threaded protrusion, such as the threaded protrusions described herein, enters the chorded section, the chords flex outward and create pressure on the threaded protrusion, which provides self-locking torque and prevents loosening during vibration, shock, or other external forces. These are well-recognized in the industry and have been used in nuclear applications outside of the Vogtle creep and growth study.

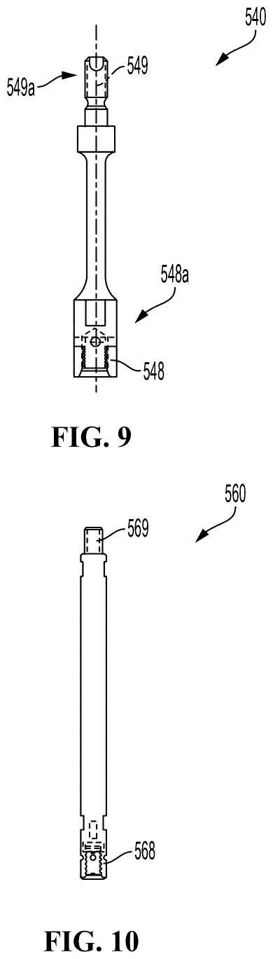

Referring to FIG. 9, the top end connector 540 comprises a locking helicoil 548 on its bottom end 548a and a threaded protrusion 549 at its top end 549a. The threaded protrusion 549 is configured to threadably engage the baseplate 510 to attach the top end connector 540 to the baseplate 510. In one embodiment, the threaded protrusion 549 extends through an opening in the baseplate 510 and is threaded into a nut welded to the top side of the baseplate 510.

Referring to FIG. 10, one of the spacers of the plurality of spacers 560 is shown. Each of the spacers comprises a locking helicoil 568 on one end and a threaded protrusion 569 on its opposite end. In one embodiment, one or more than one of the spacers 560 can vary in length in order to space apart the sample segments 550a, 550b, 550c, 550d to axially position the sample segments 550a, 550b, 550c, 550d at desired axial locations when in residence within a fuel assembly.

Referring again to FIG. 7, the sample segment 550a is a first sample segment, the sample segment 550b is a second sample segment, the sample segment 550c is a third sample segment, and the sample segment 550d is a fourth sample segment. The first sample segment 550a is attached to the top end connector 540 by way of a first one 560a of the spacers 560. Specifically, the locking helicoil 548 at the bottom of the top end connector 540 is lockingly engaged with the threaded protrusion 569 at the top of the first spacer 560, and the locking helicoil 568 at the bottom of the first spacer 560 is lockingly engaged with the threaded protrusion 559 at the top of the first sample segment 550a. Further, the first sample segment 550a is connected to the second sample segment 550b by way of a second one of the spacers 560. Specifically, the locking helicoil 558 at the bottom of the first sample segment 550a is engaged with the threaded protrusion 569 at the top of the second spacer 560, and the locking helicoil 568 at the bottom of the second spacer 560 is engaged with the threaded protrusion 559 of the second sample segment 550b. Further, the third sample segment 550c is attached to the second sample segment 550b by way of a third one of the spacers 560 and the fourth sample segment 550d is attached to the third sample segment 550c by way of a fourth one of the spacers 560 in the same or similar manner as described above with regard to the connection of the first sample segment 550a to the second sample segment 550b. A fifth spacer 560 may be attached to the bottom of the fourth sample segment 550d as shown in FIG. 7.

In use, the one or more than one test specimen 600 of each of the sample segments 550a, 550b, 550c, 550d are positionable at different axial elevations relative to the fuel assembly. As discussed above, the spacers 560 may vary in length, allowing the segmented rod 525 to be constructed with the sample segments 550a, 550b, 550c, 550d positioned at varying axial elevations relative to the fuel assembly and/or reactor core. As such, the test samples 600 within the sample segments 550a, 550b, 550c, 550d can receive different radiation dose rates when the segmented rod 525 is in residence in the fuel assembly. It should be understood that any number of sample segments and spacers may be utilized to form each rod of the plurality of segmented rods 520. Based on the desired dose rate and the known power output variance along the elevation of the fuel assembly, the plurality of segmented rods 520 will be positioned at pre-selected elevations in order to receive the desired dose rate. In at least one embodiment, one or more than one of the sample segments 550a, 550b, 550c, 550d can be an empty, or dummy, segment in order to minimize the neutronic penalty.

As discussed above, each of the sample segments 550a, 550b, 550c, 550d may be positioned at different axial elevations, and thus will experience different amounts of radiation exposure when the sample segments 550a, 550b, 550c, 550d are positioned within the fuel assembly during residence time in the reactor. As such, the one or more than one test specimen 600 housed within each of the sample segments 550a, 550b, 550c, 550d will experience different radiation levels (e.g., different dose rates) during operation of the reactor. In various embodiments, the size, shape, configuration, and/or material of the test specimens can be varied across the different sample segments 550a, 550b, 550c, 550d, and/or across the different segmented rods of the plurality of segmented rods 520, as discussed in greater detail below.

In various embodiments, the one or more than one test specimen 600 of the first sample segment 550a is one or more than one first test specimen 600a and the one or more than one test specimen 600 of the second sample segment 550b is one or more than one second test specimen 600b. In one embodiment, the one or more than one first test specimen 600a comprises a first material, and the one or more than one second test specimen 600b comprises a second material that is the same as the first material. As such, in at least one instance, the same material can be exposed to different radiation does rates owing to the axial elevations of the one or more than one first test specimen 600a and the one or more than one second test specimen 600b being different. In an alternative embodiment, the first material and the second material are different.

Further to the above, in one embodiment, the one or more than one first test specimen 600a may be a first type of test specimen and the one or more than one second test specimen 600b of the second sample segment 550b may be a second type of test specimen. In one embodiment the first type of test specimen and the second type of test specimen are different. For example, the first type of test specimen may be a tensile test specimen and the second type of test specimen may be a bend test specimen. In an alternative embodiment, the first type of test specimen and the second type of test specimen are the same specimen.

In one embodiment, than one or more than one first test specimen 600a is a plurality of first test specimens 600a and the one or more than one second test specimen 600b is a plurality of second test specimens 600b. Each of the plurality of first test specimens 600a comprising a different test specimen geometry, and each of the plurality of second test specimens 600b comprising a different test specimen geometry. For example, the plurality of first test specimens 600a can comprise a tensile pull bar, a bend bar, a compact tension specimen, a TEM disc specimen, or combinations thereof and the plurality of second test specimens 600b can comprise a tensile pull bar, a bend bar, a compact tension specimen, a TEM disc specimen, or combinations thereof. In one embodiment, the plurality of first test specimens 600a and the plurality of second test specimens 600b comprise the same configuration of different test specimen geometries. In one embodiment, the plurality of first test specimens 600a and the plurality of second test specimens 600b comprise the same material. As such, in at least one aspect, the same type or configuration of test specimen geometries of the same material can be exposed to different radiation dose rates when placed in the first sample segment 550a and the second sample segment 550b, respectively, for example.

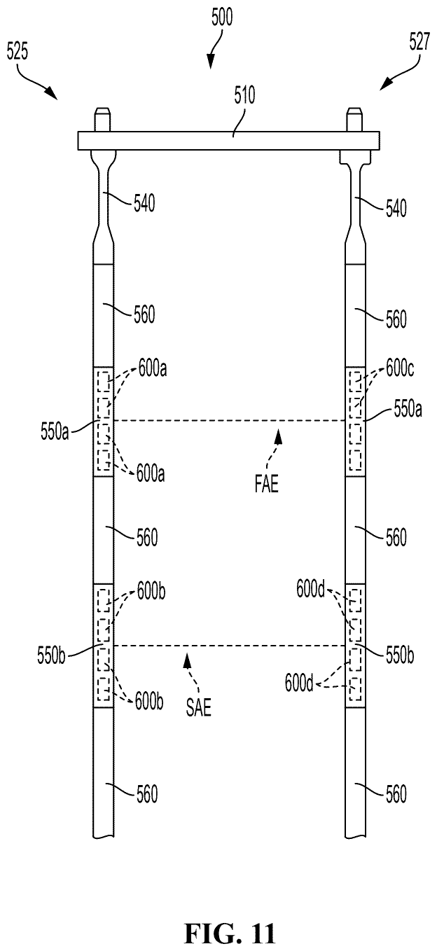

Referring to FIG. 11, the top end of the first segmented rod 525 and a second segmented rod 527 of the plurality of segmented rods 520 is illustrated. The first segmented rod 525 and the second segmented rod 527 are identical, except for the differences discussed herein. The first sample segment 550a of the first segmented rod 525 includes the one or more than one first test specimen 600a, and the second sample segment 550b of the first segmented rod 525 includes the one or more than one second test specimen 600b. Further, the first sample segment 550a of the second segmented rod 527 includes one or more than one third test specimen 600c, and the second sample segment 550b of the second segmented rod 527 includes one or more than one fourth test specimen 600d. As shown in FIG. 11, the one or more than one first test specimen 600a and the one or more than one third test specimen 600c are positioned at a first axial elevation FAE relative to the fuel assembly and/or reactor core. Further, the one or more than one second test specimen 600b and the one or more than one fourth test specimen 600d are positioned at a second axial elevation SAE relative to the fuel assembly and/or reactor core.

In use, the one or more than one first test specimen 600a and the one or more than one third test specimen 600c will receive the same, or substantially the same, radiation dose rate. Further, in use, the one or more than one second test specimen 600b and the one or more than one fourth test specimen 600d will receive the same, or substantially the same, radiation dose rate. In general, this is due to the fact that the one or more than one first test specimen 600a and the one or more than one third test specimen 600c are positioned at the same axial elevation. Similarly, the one or more than one second test specimen 600b and the one or more than one fourth test specimen 600d are also positioned at the same axial elevation and therefore receive the same, or substantially the same, radiation dose. Further, the one or more than one first test specimen 600a and the one or more than one third test specimen 600c are positioned above the one or more than one second test specimen 600b and the one or more than one fourth test specimen 600d and, thus, the one or more than one first test specimen 600a and the one or more than one third test specimen 600c will receive a different radiation dose during residence in the reactor than the one or more than one second test specimen 600b and the one or more than one fourth test specimen 600d.

Further to the above, in one embodiment, the one or more than one first test specimen 600a and the one or more than one second test specimen 600b comprise the same test specimen geometries and the same material. As such, the one or more than one first test specimen 600a and the one or more than one second test specimen 600b allow for the same material and the same test specimen geometries to be exposed to different dose rates in use. In one embodiment, the one or more than one first test specimen 600a and the one or more than one third test specimen 600c comprise different materials and/or different test specimen geometries allowing for different materials and/or different test specimen geometries to be exposed to the same, or substantially the same, radiation dose rate in residence in the reactor. Similarly, in one embodiment, the one or more than one second test specimen 600b and the one or more than one fourth test specimen 600d can comprise different materials and/or different test specimen geometries allowing for different materials and/or different test specimen geometries to be exposed to the same, or substantially the same, radiation dose rate during use.

In at least one embodiment, there may be twelve segmented rods 520 which make up the core component assembly 500. In such instances, the first sample segments 550a of each of the twelve rods are positioned at the same axial elevation and, thus, the first sample segments 550a provide twelve locations that will receive the same, or substantially the same dose rate. Similarly, the second sample segments 550b of each of the twelve rods are positioned at the same axial elevation and, thus, the second sample segments 550b provide twelve locations that will receive the same, or substantially the same dose rate. Further, the twelve first sample segments 550a are positioned at different axial elevations than the twelve second sample segments 550b providing twelve locations receiving a first dose rate and twelve locations receiving a second dose rate that is different than the first dose rate. As discussed herein, each of the plurality of segmented rods 520 can comprise four sample segments 550a, 550b, 550c, 550d, each being located at a different axial elevation. As such, the core component assembly 500 provides for twelve locations receiving a first dose rate, twelve locations receiving a second dose rate, twelve locations receiving a third dose rate, and twelve locations receiving a fourth dose rate with the first, second, third, and fourth dose rates being different.

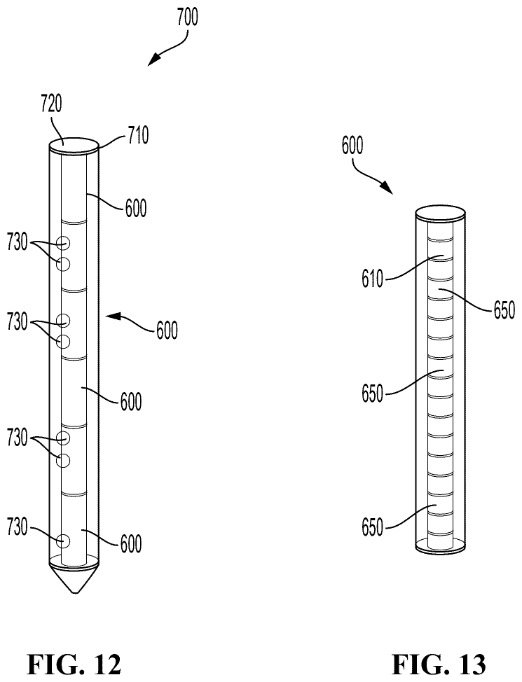

Referring to FIG. 12, rod 700 for use with a core component assembly such as the core component assembly 300 and/or 500 is illustrated. The rod 700 is attachable to a baseplate of a core component assembly, such as the baseplate 310 and/or the baseplate 510, for example. The rod 700 comprises a tubular housing 710, a cylindrical cavity 720 defined by the tubular housing 710, and a plurality of perforations, or openings 730, defined through the tubular housing 710. The rod 700 comprises a bottom end plug 740 which seals the bottom end of the rod 700. In one embodiment, the top end of the rod 700 is sealed when the rod 700 is attached to the baseplate. As such, the cylindrical cavity 720 is sealed at both ends with the openings 730 defined between the sealed ends.

Further to the above, the cylindrical cavity 720 is to house one or more than one test specimen, such as the one or more than one test specimen 600, for example. In one embodiment, the one or more than one test specimen 600 can comprise a plurality of disc segments 650 stacked and sealed within a sample segment housing 610 to form the one or more than one test specimen 600, as shown in FIG. 13. One or more than one of the sample segment housings 610 can be stacked within the cavity 720 of the rod 700. In various embodiments, spacers may be placed between the stacked disc segments 650 and/or between the sample segment housings 610 stacked in the rod 700. In one embodiment, the disc segments 650 are transmission electron microscope (TEM) discs.

Further to the above, the openings 730 of the rod 700 permit coolant to flow from outside of the rod 700 into and out of the cavity 720. For example, coolant can flow into a first opening 730 at the bottom of the rod 700 and into the cavity 720. The coolant can then flow upwardly around the one or more than one test specimen 600 positioned within cavity 720 and then exit the cavity 720 through a different one of the openings 730 above the initial opening where the coolant entered the cavity 720. Alternatively, coolant could flow downwardly within the rod 700 in a similar manner. In any event, the openings 730 permit coolant to flow through the rod 700 to cool the contents of the rod 700 when the rod is in residence within a fuel assembly of a reactor.

In an alternative embodiment, one of the plurality of segmented rods 520, such as the first segmented rod 525, can be housed within the cylindrical cavity 720 of tubular housing 710. In such an instance, the tubular housing 710 can be attached to the baseplate 510. In one embodiment, a plurality of the tubular housings 710 having segmented rods positioned therein can be attached to the baseplate 510.

As discussed above, the cylindrical cavity 553 of each sample segment 550a, 550b, 550c, 550d is to house one or more than one test specimen 600. In one embodiment, the tubular housing 552 comprises Zirconium. In various embodiments, the cavity 720 of the rod 700 is to house one or more than one test specimen 600. In one embodiment, the tubular housing 710 comprises Zirconium.

Further to the above, In various embodiments, the one or more than one test specimen 600 comprises steel, stainless steel, alloy steel, or a combination thereof. In one embodiment, the one or more than one test specimen 600 comprises a pressure vessel material. In one embodiment, the one or more than one test specimen 600 comprises a structural material used in one or more than one structural component of a nuclear reactor.

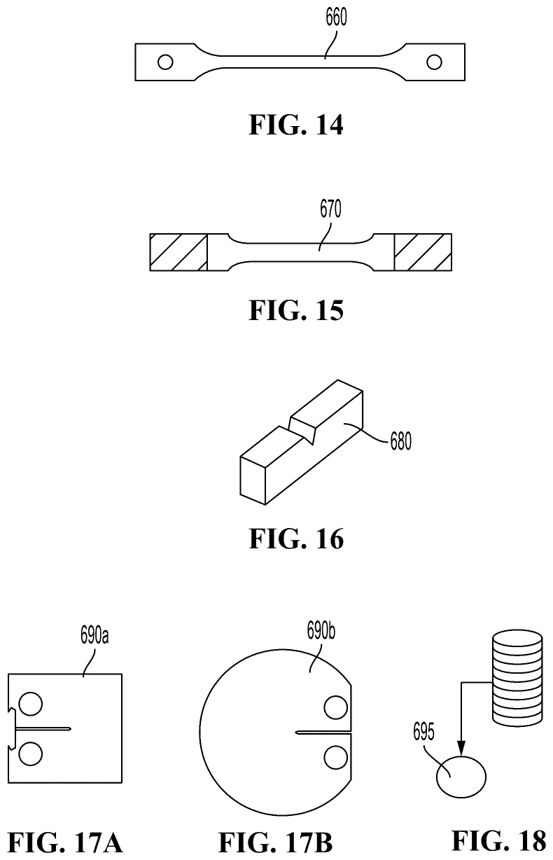

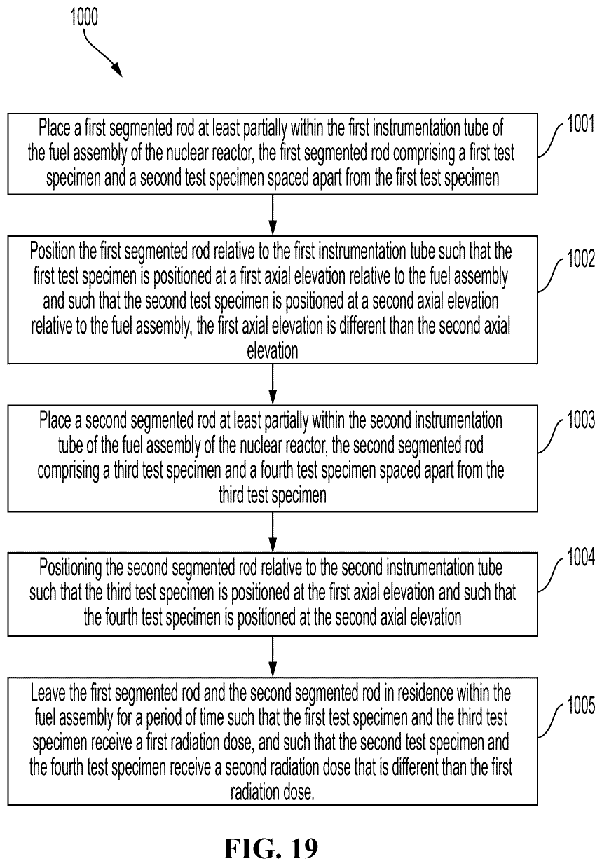

In various embodiments, the one or more than one test specimen 600 can comprise different test specimen geometries depending on the desired test that will be performed on the one or more than one test specimen 600 after irradiation. In one embodiment, the one or more than one test specimen 600 can comprises a tensile pull bar, a bend bar, a compact tension specimen, a disc specimen and/or combinations thereof. For example, FIG. 14 illustrates a dog-bone shaped tensile pull bar test specimen 660. FIG. 15 illustrates a threaded tensile bar test specimen 670. FIG. 16 illustrates a Charpy V-notch (CVN) impact test specimen 680. FIG. 17 illustrates a square, or substantially square, compact tension test specimen 690a. FIG. 17B illustrates a round compact tension test specimen 690b. FIG. 18 illustrates a plurality of TEM disc test specimens 695 stacked on top of each other. In various embodiments, one or more of the test specimen geometries illustrated in FIGS. 14-18 can be housed within the sample segments 550a, 550b, 550c, 550d and/or within the rod 700. In one embodiment, the one or more than one test specimen 600 comprises an American Society for Testing and Materials (ASTM) test specimen. In one embodiment, the one or more than one test specimen comprises a Nuclear Regulator Commission (NRC) approved test specimen.

FIG. 11 illustrates a method 1000 of irradiating a plurality of test specimens within a nuclear reactor, the nuclear reactor including a fuel assembly, such as the fuel assembly 200. The fuel assembly comprises a first instrumentation tube and a second instrumentation tube. In at least one aspect, the first instrumentation tube and the second instrumentation tube are laterally spaced apart within the same fuel assembly 200, for example.

The method 1000 comprises placing a first segmented rod, such as the first segmented rod 525, at least partially within the first instrumentation tube of the fuel assembly 200 of the nuclear reactor at step 1001. The first segmented rod 525 comprising a first test specimen, such as the one or more than one first test specimen 600a, and a second test specimen, such as the one or more than one second test specimen 600b. The first test specimen and the second test specimen are spaced apart from each other.

The method 1000 comprises positioning the first segmented rod within the instrumentation tube such that the first test specimen is positioned at a first axial elevation, such as the first axial elevation FAE, relative to the fuel assembly 200 and such that the second test specimen is positioned at a second axial elevation, such as the second axial elevation SAE, relative to the fuel assembly at step 1002. The first axial elevation is different than the second axial elevation.

The method further comprises placing a second segmented rod, such as the second segmented rod 527, at least partially within the second instrumentation tube of the fuel assembly 200 of the nuclear reactor at step 1003. The second segmented rod comprising a third test specimen, such as the third test specimen 600c, and a fourth test specimen, such as the fourth test specimen 600d. The third test specimen 600c and the fourth test specimen 600d are spaced apart from each other.

The method 1000 further comprises positioning the second segmented rod within the second instrumentation tube such that the third test specimen is positioned at the first axial elevation FAE and such that the fourth test specimen is positioned at the second axial elevation SAE at step 1004.

The method 1000 further comprises leaving the first segmented rod 525 and the second segmented rod 527 in residence within the fuel assembly 200 for a period of time such that the first test specimen 600a and the third test specimen 600c receive a first radiation dose, and such that the second test specimen 600b and the fourth test specimen 600d receive a second radiation dose that is different than the first radiation dose at step 1005.

Further to the above, after the test specimens 600 of the segmented rods 520 and/or the rod 700 are irradiated for an amount of time in residence in the reactor, the core component assembly 500 can be removed from the reactor and the one or more than one test specimen 600 can be extracted for testing.

The ability to irradiate test specimens, such as the test specimens 600, at differential dose rates and to keep test assemblies in residence for differential times allows for a comparative analysis of degradation (e.g., hardening and/or embrittlement) at various doses and dose rates. In one aspect, test specimens held at the same axial elevation may be kept in residence for different lengths of time to examine degradation as a function of dose. In one aspect, test specimens held at differential axial elevations may be kept in residence within the fuel assembly to maintain the same dose at different dose rates to evaluate dose rate effects. In the case of pressure vessel surveillance capsules, material may be irradiated to known doses and tested for comparison to archived surveillance material to confirm the dose rate effects of positioning in in-core positions rather than at the downcomer flow region. In various aspects, this may serve as a validation for future surveillance testing to a calculated 60-, 80-, or 100-year dose. As such, various desirable outcomes can be achieved by irradiating test materials at desired dose rates to desired doses for mechanical and microstructural evaluation. In at least one aspect, the desired outcome may be to irradiate test materials at desired dose rates to desired doses for mechanical and microstructural evaluation.

Various aspects of the present disclosure include, but are not limited to, the aspects listed in the following numbered clauses.
Clause 1—A core component assembly for use with a fuel assembly of a nuclear reactor. The core component assembly comprises a baseplate and a segmented rod to extend into the fuel assembly. The segmented rod comprises a plurality of sample segments. Each sample segment comprises a tubular housing, a cylindrical cavity defined in the tubular housing, a first plug to seal a first end of the tubular housing, and a second plug to seal a second end of the tubular housing opposite the first end. The cylindrical cavity is to house one or more than one test specimen.
Clause 2—The core component assembly of Clause 1, wherein the one or more than one test specimen having a test specimen geometry, and wherein the test specimen geometry comprises a tensile pull bar, a bend bar, a compact tension specimen, a TEM disk specimen, or a combination thereof.
Clause 3—The core component assembly of Clause 1 or 2, wherein the plurality of sample segments comprise a first sample segment and a second sample segment, and wherein the first sample segment and the second sample segment are positioned at different axial elevations within the fuel assembly.
Clause 4—The core component assembly of Clause 3, wherein the second sample segment comprises one or more than one second test specimen, wherein the one or more than one first test specimen comprises a first material, wherein the one or more than one second test specimen comprises a second material, and wherein the first material and the second material are the same material.
Clause 5—The core component assembly of Clause 3 or 4, wherein the segmented rod further comprises a top connector segment for attaching the segmented rod to the baseplate, and a spacer segment positioned intermediate the first sample segment and the second sample segment to position the first sample segment and the second sample segment at different axial elevations within the fuel assembly.
Clause 6—The core component assembly of Clause 5, wherein the spacer segment, the first sample segment, and the second sample segment each comprises a locking helicoil at one end and a protrusion at the opposite end to attach the spacer segment, the first sample segment, and the second sample segment to each other and to the top connector segment.
Clause 7—The core component assembly of Clause 4, wherein the segmented rod is a first segmented rod, wherein the core component assembly further comprises a second segmented rod to extend into the fuel assembly, and wherein the second segmented rod comprises a third sample segment positioned at the same axial elevation as the first sample segment of the first segmented rod.
Clause 8—The core component assembly of Clause 7, wherein the third sample segment comprises one or more than one third test specimen, wherein the one or more than one third test specimen comprises a third material, and wherein the third material is different than the first material.
Clause 9—The core component assembly of Clauses 4, 5, 6, 7, or 8, wherein the tubular housing comprises Zirconium, and wherein the first material comprises one of steel, stainless steel, alloy steel, or a combination thereof.
Clause 10—The core component assembly of Clauses 1, 2, 3, 4, 5, 6, 7, 8, or 9, further comprising an outer tube attached to the baseplate, wherein the segmented rod is positioned within the outer tube.
Clause 11—A method of irradiating a plurality of test specimens within a nuclear reactor, the nuclear reactor including a fuel assembly comprising a first instrumentation tube and a second instrumentation tube, the method comprising placing a first segmented rod at least partially within the first instrumentation tube of the fuel assembly of the nuclear reactor. The first segmented rod comprising a first test specimen and a second test specimen spaced apart from the first test specimen. The method comprising positioning the first segmented rod relative to the first instrumentation tube such that the first test specimen is positioned at a first axial elevation relative to the fuel assembly and such that the second test specimen is positioned at a second axial elevation relative to the fuel assembly. The first axial elevation is different than the second axial elevation. The method comprising placing a second segmented rod at least partially within the second instrumentation tube of the fuel assembly of the nuclear reactor, the second segmented rod comprising a third test specimen and a fourth test specimen spaced apart from the third test specimen. The method comprising positioning the second segmented rod relative to the second instrumentation tube such that the third test specimen is positioned at the first axial elevation and such that the fourth test specimen is positioned at the second axial elevation. The method comprising leaving the first segmented rod and the second segmented rod in residence within the fuel assembly for a period of time such that the first test specimen and the third test specimen receive a first radiation dose, and such that the second test specimen and the fourth test specimen receive a second radiation dose that is different than the first radiation dose.
Clause 12—The method of Clause 11, wherein at least one of the first test specimen, the second test specimen, the third test specimen, and the fourth test specimen comprises a test specimen geometry, and wherein the test specimen geometry comprises a tensile pull bar, a bend bar, a compact tension specimen, a TEM disk specimen, or a combination thereof.
Clause 13—The method of Clause 11 or 12, further comprising removing the first and second segmented rods from the fuel assembly and extracting the first, second, third, and fourth test specimens from their respective segmented rod.
Clause 14—The method of Clause 13, further comprising testing the first, second, third, and fourth test specimens to determine the level of embrittlement of each of the first, second, third, and fourth test specimens.
Clause 15—The method of Clause 14, further comprising comparing the test results to determine the effect of irradiation dose and dose rate on material mechanical and microstructural evolution.
Clause 16—The method of Clause 13, further comprising testing the first, second, third, and fourth test specimens to determine the level of degradation caused by radiation to each of the first, second, third, and fourth test specimens.
Clause 17—The method of Clause 16, further comprising comparing the test results to determine effect of irradiation dose and dose rate on material mechanical and microstructural evolution.
Clause 18—The method of Clauses 11, 12, 13, 14, 15, 16, or 17, wherein the first test specimen and the second test specimen comprise a first material, wherein the third test specimen and the fourth test specimen comprise a second material, and wherein the first material and the second material are different.
Clause 19—The method of Clauses 11, 12, 13, 14, 15, 16, or 17, wherein the first test specimen comprise a first material, the second test specimen comprises a second material, the third test specimen comprises a third material, and the fourth test specimen comprises a fourth material, and wherein the first material and the third material are different.
Clause 20—The method of Clause 19, wherein the second material and the fourth material are different.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present disclosure has been described with reference to various exemplary and illustrative aspects. The aspects described herein are understood as providing illustrative features of varying detail of various aspects of the disclosed disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed disclosure. Accordingly, it will be recognized by persons having ordinary skill in the art that various substitutions, modifications or combinations of any of the exemplary aspects may be made without departing from the scope of the disclosure. In addition, persons skilled in the art will recognize, or be able to ascertain using no more than routine experimentation, many equivalents to the various aspects of the disclosure described herein upon review of this specification. Thus, the disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A core component assembly for use with a fuel assembly of a nuclear reactor, wherein the core component assembly comprises:
a baseplate; and
a segmented rod to extend into the fuel assembly, the segmented rod comprises a plurality of sample segments, each sample segment comprises:
a tubular housing;
a cylindrical cavity defined in the tubular housing, wherein the cylindrical cavity is to house one or more than one test specimen;
a first plug to seal a first end of the tubular housing; and
a second plug to seal a second end of the tubular housing opposite the first end.

2. The core component assembly of claim 1, wherein the one or more than one test specimen having a test specimen geometry, and wherein the test specimen geometry comprises a tensile pull bar, a bend bar, a compact tension specimen, a TEM disk specimen, or a combination thereof.

3. The core component assembly of claim 1, wherein the plurality of sample segments comprise a first sample segment and a second sample segment, and wherein the first sample segment and the second sample segment are positioned at different axial elevations within the fuel assembly.

4. The core component assembly of claim 3, wherein the second sample segment comprises one or more than one second test specimen, wherein the one or more than one first test specimen comprises a first material, wherein the one or more than one second test specimen comprises a second material, and wherein the first material and the second material are the same material.

5. The core component assembly of claim 3, wherein the segmented rod further comprises:
a top connector segment for attaching the segmented rod to the baseplate; and
a spacer segment positioned intermediate the first sample segment and the second sample segment to position the first sample segment and the second sample segment at different axial elevations within the fuel assembly.

6. The core component assembly of claim 5, wherein the spacer segment, the first sample segment, and the second sample segment each comprises a locking helicoil at one end and a protrusion at the opposite end to attach the spacer segment, the first sample segment, and the second sample segment to each other and to the top connector segment.

7. The core component assembly of claim 4, wherein the segmented rod is a first segmented rod, wherein the core component assembly further comprises a second segmented rod to extend into the fuel assembly, and wherein the second segmented rod comprises a third sample segment positioned at the same axial elevation as the first sample segment of the first segmented rod.

8. The core component assembly of claim 7, wherein the third sample segment comprises one or more than one third test specimen, wherein the one or more than one third test specimen comprises a third material, and wherein the third material is different than the first material.

9. The core component assembly of claim 4, wherein the tubular housing comprises Zirconium, and wherein the first material comprises one of steel, stainless steel, alloy steel, or a combination thereof.

10. The core component assembly of claim 1, further comprising an outer tube attached to the baseplate, wherein the segmented rod is positioned within the outer tube.

11. A method of irradiating a plurality of test specimens within a nuclear reactor, the nuclear reactor including a fuel assembly comprising a first instrumentation tube and a second instrumentation tube, the method comprising:
placing a first segmented rod at least partially within the first instrumentation tube of the fuel assembly of the nuclear reactor, the first segmented rod comprising a first test specimen and a second test specimen spaced apart from the first test specimen;
positioning the first segmented rod relative to the first instrumentation tube such that the first test specimen is positioned at a first axial elevation relative to the fuel assembly and such that the second test specimen is positioned at a second axial elevation relative to the fuel assembly, the first axial elevation is different than the second axial elevation;
placing a second segmented rod at least partially within the second instrumentation tube of the fuel assembly of the nuclear reactor, the second segmented rod comprising a third test specimen and a fourth test specimen spaced apart from the third test specimen;
positioning the second segmented rod relative to the second instrumentation tube such that the third test specimen is positioned at the first axial elevation and such that the fourth test specimen is positioned at the second axial elevation; and
leaving the first segmented rod and the second segmented rod in residence within the fuel assembly for a period of time such that the first test specimen and the third test specimen receive a first radiation dose, and such that the second test specimen and the fourth test specimen receive a second radiation dose that is different than the first radiation dose.

12. The method of claim 11, wherein at least one of the first test specimen, the second test specimen, the third test specimen, and the fourth test specimen comprises a test specimen geometry, and wherein the test specimen geometry comprises a tensile pull bar, a bend bar, a compact tension specimen, a TEM disk specimen, or a combination thereof.

13. The method of claim 11, further comprising removing the first and second segmented rods from the fuel assembly and extracting the first, second, third, and fourth test specimens from their respective segmented rod.

14. The method of claim 13, further comprising testing the first, second, third, and fourth test specimens to determine the level of embrittlement of each of the first, second, third, and fourth test specimens.

15. The method of claim 14, further comprising comparing the test results to determine the effect of irradiation dose and dose rate on material mechanical and microstructural evolution.

16. The method of claim 13, further comprising testing the first, second, third, and fourth test specimens to determine the level of degradation caused by radiation to each of the first, second, third, and fourth test specimens.

17. The method of claim 16, further comprising comparing the test results to determine effect of irradiation dose and dose rate on material mechanical and microstructural evolution.

18. The method of claim 11, wherein the first test specimen and the second test specimen comprise a first material, wherein the third test specimen and the fourth test specimen comprise a second material, and wherein the first material and the second material are different.

19. The method of claim 11, wherein the first test specimen comprise a first material, the second test specimen comprises a second material, the third test specimen comprises a third material, and the fourth test specimen comprises a fourth material, and wherein the first material and the third material are different.

20. The method of claim 19, wherein the second material and the fourth material are different.
